(19) United States
(12) Patent Application Publication
(10) Pub. No.: US 2012/0163646 A1
(43) Pub. Date: Jun. 28, 2012

(54) WIRELESS MICROPHONE

(75) Inventor: Tenor Chen, Chiayi City (TW)

(73) Assignee: Mipro Electronics Co., Ltd., Chiayi (TW)

(21) Appl. No.: 12/977,246

(22) Filed: Dec. 23, 2010

(51) Int. Cl. H04R 11/04

(52) U.S. Cl. 381/355

(57) ABSTRACT

A wireless microphone includes a barrel that includes a grip having top and bottom ends. The barrel further includes a battery accommodating section connected to the bottom end of the grip. The battery accommodating section has at least one battery seat formed with an outward opening and configured for receiving and electrically connecting to a battery, and is formed with an accommodation space disposed adjacent to the at least one battery seat. The wireless microphone further includes a battery cap removably sleevable over the battery accommodating section, and an audio pick-up unit mounted to the top end of the grip and configured to pick-up a sound signal. In addition, the wireless microphone includes a circuit unit that includes a control circuit board and an antenna.

### BACKGROUND OF THE INVENTION

1. Field of the Invention

The invention relates to a microphone device, and more particularly to a wireless microphone.

2. Description of the Related Art

As shown in FIG. 1, an antenna 12 is installed at a bottom end of a conventional microphone 1. The antenna 12 adds to the length of the conventional microphone 1, and is exposed to impacts that may damage the microphone 1.

As shown in FIG. 2, an antenna 12′ is disposed at an outer surface of another conventional wireless microphone 1′, where the antenna 12′ may be covered or contacted by the hand of a user or other objects. This may shorten the effective transmission distance of the conventional wireless microphone 1′, interfere with communication quality, or cause unpleasant changes in the audio volume of sound transmitted through the conventional microphone 1′.

### SUMMARY OF THE INVENTION

Therefore, an object of the present invention is to provide a wireless microphone that can alleviate the above drawbacks of the prior art.

Accordingly, the preferred embodiment of a wireless microphone of the present invention includes a barrel that includes a grip having top and bottom ends. The barrel further includes a battery accommodating section connected to the bottom end of the grip. The battery accommodating section has at least one battery seat formed with an outward opening and configured for receiving and electrically connecting to a battery, and is formed with an accommodation space disposed adjacent to the at least one battery seat. The wireless microphone further includes a battery cap removably sleevable over the battery accommodating section, and an audio pick-up unit mounted to the top end of the grip and configured to pick-up a sound signal. In addition, the wireless microphone includes a circuit unit that includes a control circuit board and an antenna. The control circuit board is mounted in the grip and coupled electrically between the audio pick-up unit and the at least one battery seat, and the antenna is disposed in the accommodation space and connected electrically to the control circuit board.

Some advantages of the present invention include reduction of the wireless microphone length, and improved protection of the antenna against accidental impact. In addition, the position of the antenna makes it less likely to be contacted during ordinary use, which may improve communication quality.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional wireless microphone;

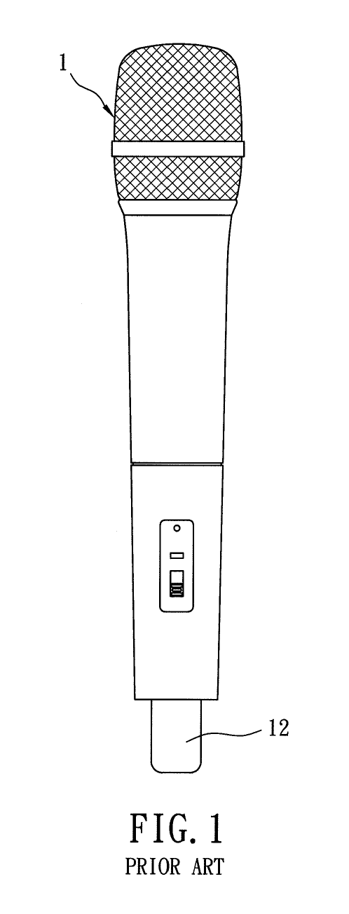

FIG. 2 is a schematic view of another conventional wireless microphone;

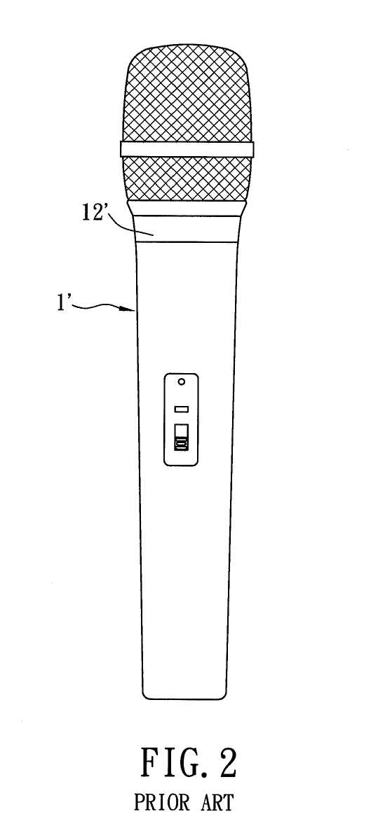

FIG. 3 is a partly exploded perspective view of the preferred embodiment of a wireless microphone according to the present invention;

FIG. 4 is a fragmentary enlarged partly exploded perspective view of the preferred embodiment; and

FIG. 5 is a fragmentary sectional view of the preferred embodiment.

### DETAILED DESCRIPTION OF THE PREFERRED EMBODIMENT

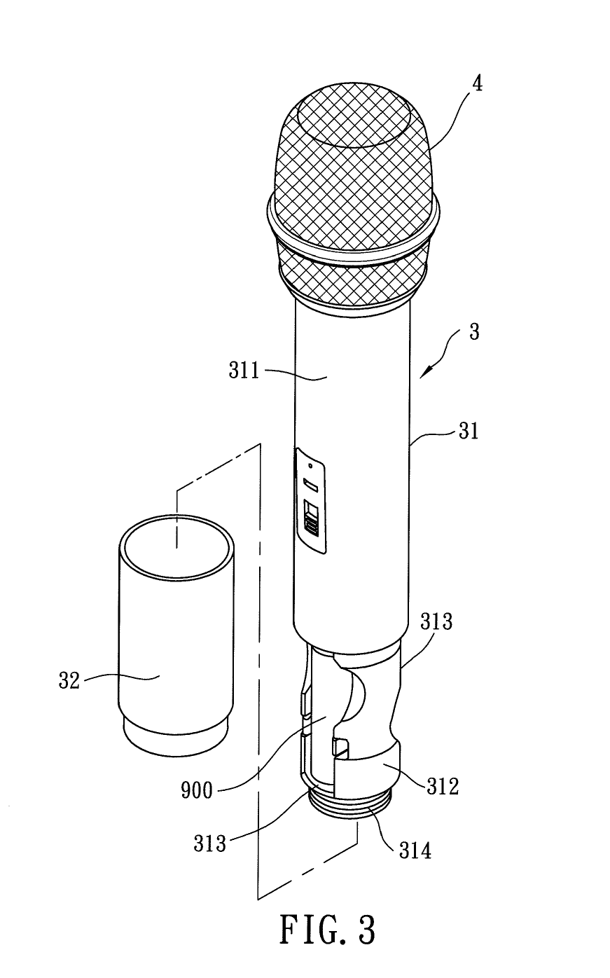

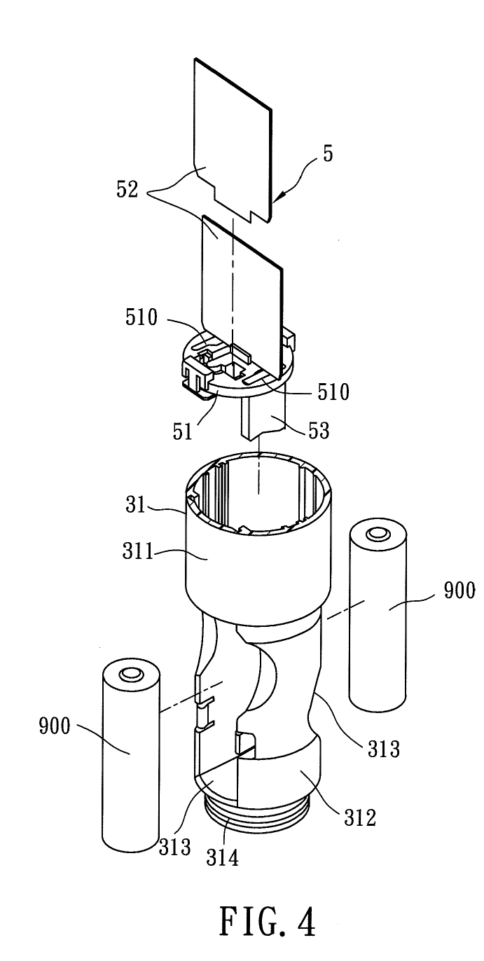

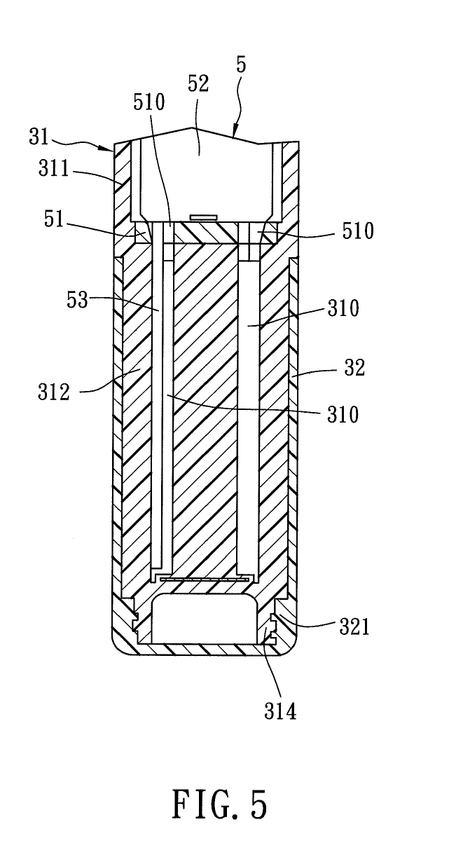

Referring to FIGS. 3 to 5, the preferred embodiment of a wireless microphone according to the present invention is configured for wireless communication with a wireless signal receiver (not shown in the Figure) and includes a housing 3, an audio pick-up unit 4 mounted fixedly under a mesh cover disposed at a top end of the housing 3, and a circuit unit 5 mounted fixedly in the housing 3.

The housing 3 includes an elongate barrel 31 and a battery cap 32 sleevable removably on an outer periphery of a lower section of the barrel 31. The barrel 31 has a grip 311 that has top and bottom ends, and a battery accommodating section 312 that is shorter than the grip 311 and connected to the bottom end of the grip 311. The battery accommodating section 312 has two battery seats 313, each formed with an outward opening and configured for receiving and electrically connecting to a battery 900. The battery accommodating section 312 further has a threaded end 314, and is formed with a pair of spaced apart accommodation spaces 310 that extend vertically and that are disposed between the battery seats 313.

The battery cap 32 is sleevable removably over the battery accommodating section 312, is configured for completely shielding the battery seats 313, and has a threaded part 321 for threaded engagement with the threaded end 314 of the battery accommodating section 312.

The audio pick-up unit 4 is mounted fixedly on a top of the grip 311 and is configured to pick up a sound signal for subsequent conversion into electric signals for further output. The audio pick-up unit 4 is known in the art and will not be described in additional detail herein for the sake of brevity.

The circuit unit 5 includes abase 51 mounted between the grip 311 and the battery accommodating section 312. The base 51 is formed with a pair of insert holes 510 in spatial communication with the accommodation spaces 310, respectively. The circuit unit 5 further includes a pair of control circuit boards 52 mounted in the grip 311 and connected electrically between the audio pick-up unit 4 and the battery seats 313, and an antenna 53 connected electrically to the control circuit boards 52. The antenna 53 extends downward through one of the insert holes 510 of the base 51 and into one of the accommodation spaces 310.

The control circuit boards 52 are for receiving and processing electric signals from the audio pick-up unit 4 for subsequent transmission to the antenna 53 for further wireless transmission to the signal receiver. The control circuit boards 52 and the antenna 53 are known in the art and will not be further detailed hereinafter for the sake of brevity.

During use of the wireless microphone, the grip 311 of the barrel 31 is configured to be held by a user. Because the antenna 53 is mounted in the battery accommodating section 312 of the barrel 31 separate from the grip 311, the hand of the user will not ordinarily mask the antenna 53. Communication quality using the antenna 53 is therefore improved, and stable communication between the wireless microphone and the signal receiver may be maintained.

Moreover, because the antenna 53 is hidden and protected in the battery accommodating section 312, additional structure for mounting the antenna 53 over a bottom end of the barrel 31 is unnecessary, which simplifies manufacturing and assembly of the preferred embodiment of the wireless microphone, which also significantly reduces manufacturing costs compared to the conventional microphones 1, 1′. Furthermore, the protection provided by the battery cap 32 and the barrel 31 significantly reduces the risk of damage to the antenna 53 due to accidental impact.

In summary, by mounting the antenna 53 in the battery accommodating section 312, manufacture and assembly of of the preferred embodiment is simplified, manufacturing costs are reduced, and the risk of damage to the antenna due to accidental impact is greatly reduced. In addition, given that contact between the antenna and a user's hand during ordinary use is prevented, the communication quality of the microphone is likely to be improved.

While the present invention has been described in connection with what is considered the most practical and preferred embodiment, it is understood that this invention is not limited to the disclosed embodiment but is intended to cover various arrangements included within the spirit and scope of the broadest interpretation to encompass all such modifications and equivalent arrangements.

What is claimed is:

1. A wireless microphone comprising:
a barrel that includes
a grip having top and bottom ends, and
a battery accommodating section connected to said bottom end of said grip, having at least one battery seat formed with an outward opening and configured for receiving and electrically connecting to a battery, and formed with an accommodation space disposed adjacent to said at least one battery seat;
a battery cap removably sleevable over said battery accommodating section;
an audio pick-up unit mounted to said top end of said grip and configured to pick-up a sound signal; and
a circuit unit that includes
a control circuit board mounted in said grip and coupled electrically between said audio pick-up unit and said at least one battery seat, and
an antenna disposed in said accommodation space and connected electrically to said control circuit board.

2. The wireless microphone as claimed in claim 1, wherein said circuit unit further includes a base mounted between said grip and said battery accommodating section, said control circuit board is mounted to said base, and said antenna extends from said base into said accommodation space.
